(19) United States
(12) Patent Application Publication
(10) Pub. No.: US 2008/0021908 A1
(43) Pub. Date: Jan. 24, 2008

(54) Synchronization and dynamic resizing of a segmented linear hash table

(76) Inventors: Barrett Alan Trask, Lafayette, CO (US); Harold Michael Wenzel, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/489,884

(22) Filed: Jul. 20, 2006

(51) Int. Cl. G06F 7/00

(52) U.S. Cl. 707/100

(57) ABSTRACT

One exemplary system and method for managing access to data records in a multiprocessor computing environment. The system and method allocates a segmented linear hash table for storing the data records, performs a modification operation on the segmented linear hash table, performs a table restructuring operation on the segmented linear hash table in parallel with the modification operation, and performs at least one lookup operation on the segmented linear hash table in parallel with each other and with the modification operation or the table restructuring operation.

### BACKGROUND

Traditional hash table data structures suffer from a common trade-off of space versus efficiency. If the table is designed to perform well under maximum load, the space overhead of the table itself can be significant. On the other hand, if the space overhead of the table is minimized and the data set grows, the table must be resized to maintain performance with the higher workload. Resizing the hash table is generally a very costly operation, since it involves rehashing each item (i.e., the structure for each datum stored in the hash table on behalf of the user) into the new table. Meanwhile, lookups are held off until the hash table's data structure is once again in a consistent state.

An alternative algorithm for growing a hash table, called linear hashing, has been developed for use in database systems. The present invention utilizes a linear hashing algorithm for in-memory hashing of data. The present invention extends the linear hashing algorithm by controlling data structure memory to optimize speed versus space. The present invention minimizes search time and maximizes parallelism by allowing searches to proceed in parallel with table restructuring without employing locks. The present invention minimizes contention for locks by allowing insertions and deletions to proceed in parallel. The present invention ensures the multiprocessing (MP) safety of the algorithm by accommodating central processing units (CPUs) of different speeds on the same platform. Finally, the present invention defines the algorithms in such a way that the algorithms can be implemented as an optimized, separate utility module, rather than as code entangled with the user's module (i.e., a module associated with the caller of the hash table interfaces). The present invention addresses these needs.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is a block diagram that illustrates the relationship between two table-global fields in a linear hash table.

FIG. 2 is a block diagram that illustrates the structure of a segmented linear hash table in accordance with an exemplary embodiment of the present invention.

FIGS. 3A and 3B illustrate the algorithm for inserting an item into a segmented linear hash table in accordance with an exemplary embodiment of the present invention.

FIG. 3C illustrates the algorithm for deleting an item from a segmented linear hash table in accordance with an exemplary embodiment of the present invention.

FIGS. 4A, 4B, and 4C illustrate the movement of items from one bucket to another bucket as a segmented linear hash table grows in accordance with an exemplary embodiment of the present invention.

FIG. 5 is a flow diagram that illustrates the logic for managing access to the data records.

FIG. 6 is a flow diagram that illustrates the procedure for initializing a segmented hash table.

FIG. 7 is a flow diagram that illustrates the procedure to add an item to, or delete an item from, the hash table.

FIG. 8 is a flow diagram that illustrates the process for expanding or shrinking the table.

### DETAILED DESCRIPTION

### Overview of Segmented Linear Hashing

Linear hashing algorithms allow for incremental (linear) growth of a hash table to accommodate additional data load, but in a way that all items in the table need not be rehashed at once. Linear hashing accomplishes this by placing items in the hash table in a deterministic manner (independent of the number of rows in the current table, n) so those items can be quickly found and moved without searching the table. Only the low order bits of the hash value are used to distribute the data (note that this may put additional requirements on what constitutes a “good” hash function, a function designed to spread key values (i.e., the value used for lookups, wherein if the key is a string, it is first folded to a numeric value via a mechanism such as a checksum before hashing) as evenly as possible over the number space limited by n).

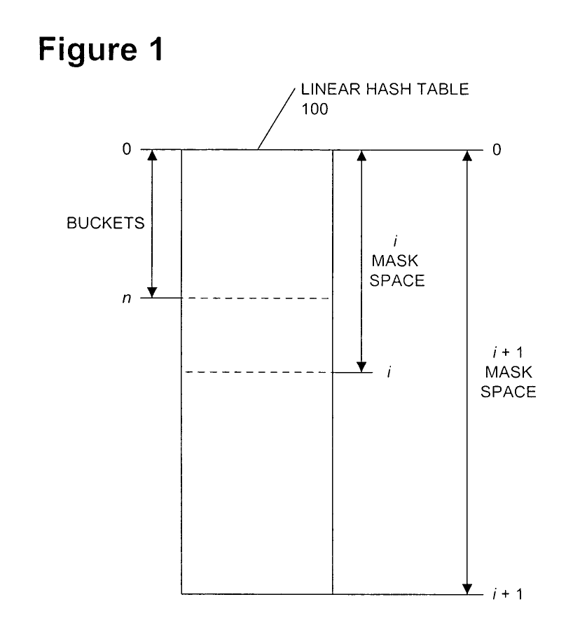

Linear hashing maintains two table-global integer fields to guide the hash function to the correct bucket (i.e., a container for items that hash to the same index in the table that is typically implemented as a linked list) in the table (zero-indexed). The first table-global integer field is n, which simply represents the number of buckets in the current table. The second table-global integer field is i, the number of low order bits of the hash value currently being used to index into the table. FIG. 1 illustrates the relationship between the two table-global fields in a linear hash table. For the linear hash table 100 shown in FIG. 1, the number of buckets, n, moves up and down as the table grows and shrinks. When the linear hash table 100 grows beyond the space defined by the current mask space, i, the mask space jumps up or down by a power-of-two in size to the i+1 mask space. If a masked hash value falls above the number of buckets, n, we subtract 2⁽ⁱ⁻¹⁾ from the masked hash value to bring the value back within the current table bounds, n. It will be important to be able to visualize this as we go through the dynamic behavior of the algorithms.

The following index-selection algorithm identifies the correct bucket. In this algorithm, m is the low order i bits of the hash value of key k. If m is less than n, then bucket m is used. Otherwise, bucket m−2⁽ⁱ⁻¹⁾ is chosen. The relationship among these variables is 1≦n≦2ⁱ and 0≦m≦2ⁱ−1. The following is pseudo-code for the index-selection algorithm.

```
Get_index(table, hash) {
    i_tmp <- table->i  /* avoid race on i changing */
    m <- hash & ((2\hat{ }i_tmp) − 1)
    if (m < table->n) {
      bucket <- m
    } else {
      bucket <- (m − 2\hat{ }(i_tmp − 1))
    }
}
```

The net effect of the index-selection algorithm is to place each item into a known location in the table. When the table needs to grow to accommodate more buckets, the rehash daemon knows in which bucket to look to find the items needed to place in the newly-allocated bucket.

The decision to grow (or equivalently, to shrink) is based on a threshold that represents table “fullness”. This metric can be the current number of hashed items divided by n, the current number of buckets (i.e., hash headers, the indexed element of the hash table that include a pointer to the hash bucket as well as associated locks or other data) compared with r, the target maximum ratio. Alternatively, the decision could be based on an absolute value of hashed items. The key is that the threshold represents a limit on the average number of items per bucket (chain length), which is a measure of the time factor associated with a lookup or delete operation.

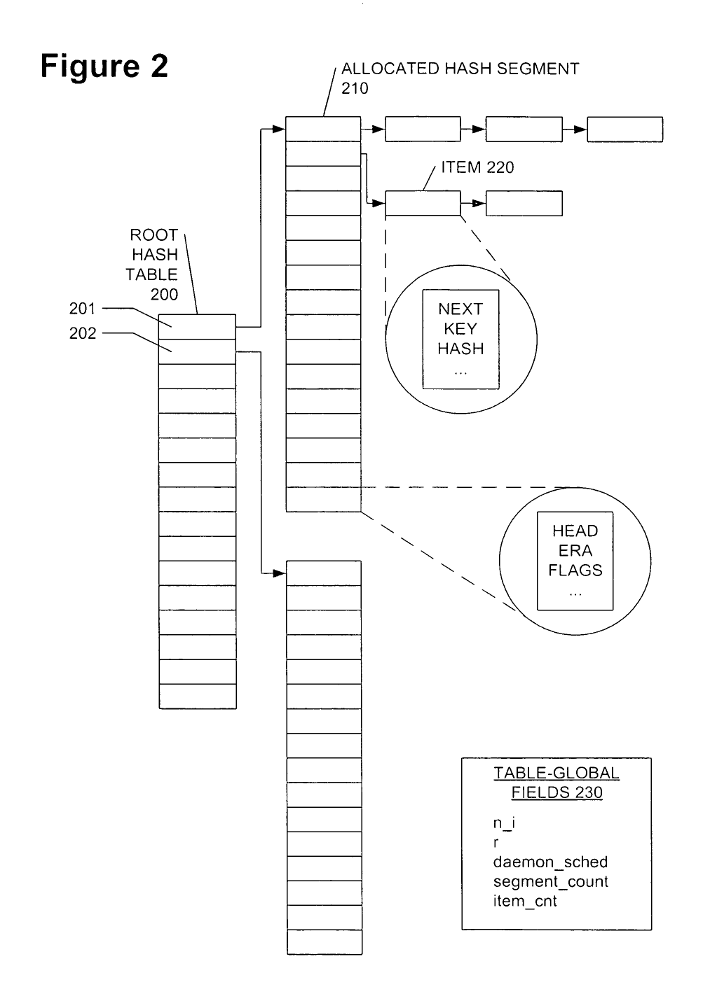

The present invention extends this basic linear hashing algorithm to handle the practical problems of not being able to allocate an arbitrarily large hash array, and the relatively unbounded time required to clone the hash bucket pointers into a newly-allocated replacement array when the table grows or shrinks. The mechanism for doing this is simply to make the table pseudo-contiguous and use a fixed top-level “root” array to reference the table segments (i.e., each of which is a contiguous portion of allocated memory that holds part of the hash table). FIG. 2 is a block diagram that illustrates the structure of a segmented linear hash table in accordance with an exemplary embodiment of the present invention. As shown in FIG. 2, the root hash table 200 is an implementation of the linear hash table 100 shown in FIG. 1. The root hash table 200 comprises pointer references 201, 202. The first pointer reference 201 in the root hash table 200 corresponds to index 0, the second pointer reference 202 is e, etc. Each pointer reference in the root hash table 200 refers to an allocated hash segment 210. The allocated hash segment 210 comprises e buckets, where e is a power-of-two. Each bucket is associated with a data structure that includes HEAD, a pointer to the first item 220 in a linked list of items, ERA, a variable to count non-lookup accesses to the bucket, and FLAGS which indicate the occurrence or non-occurrence of a condition. Similarly, the item 220 has a data structure that includes NEXT, a pointer to the next item 220 in the linked list of items, KEY, a value used to locate the data in the hash table, and HASH, the hash value computed for the key. The root hash table 200 further comprises table-global fields 230 that include n_i, daemon_sched, segment_count, and item_cnt. The n and i fields for the index-selection algorithm are packed into a 64-bit field, n_i, and are read and written atomically so that their values are always coherent. The least-significant byte contains i, so unpacking n simply involves a right-shift of 8 bits. Segments are a power-of-two in size (e or BUCKETS_PER_SEG hash headers) and are expected to be relatively large (page size). Finding the proper segment and index involves the use of two constants, SEG_BITS and SEG_MASK. The SEG_BITS constant is the power-of-two value that corresponds to the segment size. A right-shift of the bucket hash value obtained from the Get_index( ) function above by SEG_BITS obtains the proper index in the Root Table. The second constant, SEG_MASK, is a mask with a one in each bit position needed to enumerate all the hash headers in a segment (i.e., the remainder of the bucket value after the Root Table index is found). A bitwise-AND of this mask with the bucket hash value obtains the index in the segment (SEG_MASK=(1<<SEG_BITS)−1).

In addition to the data structures shown in FIG. 2, there is also an array of bucket “hashed” spinlock pointers. This array is also a power-of-two but is less than or equal to the size of a segment. We also introduce another constant, LOCK_MASK, similar to SEG_MASK. A bitwise-AND of this mask with the bucket hash value obtains the index into the lock array.

The table-global fields 230 for the root hash table 200 are not protected by a lock on an Intel Architecture (IA) processor. However, some provision for atomic increments and decrements is necessary for the segment_count field, but on an IA processor, for example, there are machine instructions for this. On other processors, such as the Precision Architecture (PA) processors, a spinlock is necessary.

### Synchronizing Lookup and Modification Operations

To allow the best parallelism for lookups, no locks are used by threads that perform a simple lookup. To maximize the parallelism of insertions, deletions and the item-moves related to growing and shrinking the table, a “hashed” spinlock is used for each bucket. Notice that because of the power-of-two relationship between the size of a segment and the size of the lock array, and because of the way each is indexed, the hash header (bucket) at the same offset in each segment is protected by the same lock. This allows a single lock to be acquired to protect both the source and destination buckets when items are relocated between buckets when the table grows or shrinks. This minimizes lock overhead and eliminates lock ordering problems. To view the locking scheme from the point of view of a hashed item, once a hashed item is protected by a particular lock for modification, that lock will be used any time that item must be moved or modified.

### Insert/Delete Basics

We will discuss the full algorithm for inserting or deleting an item from the table in a later subsection. However, in order to better understand all the algorithms, we will first take a close look at the basic pointer manipulations being used to insert or delete an item from a bucket list.

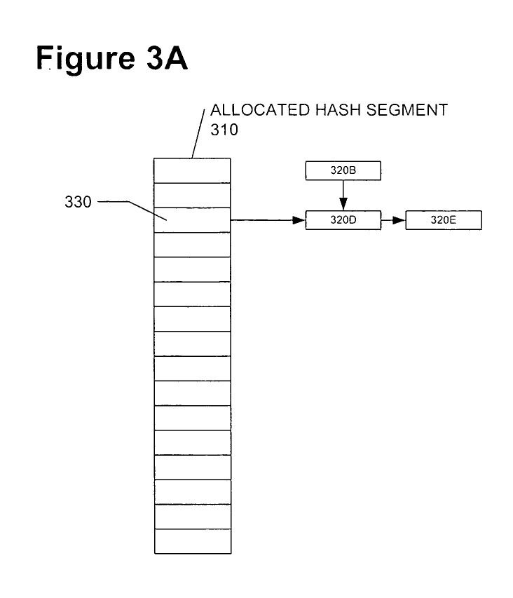

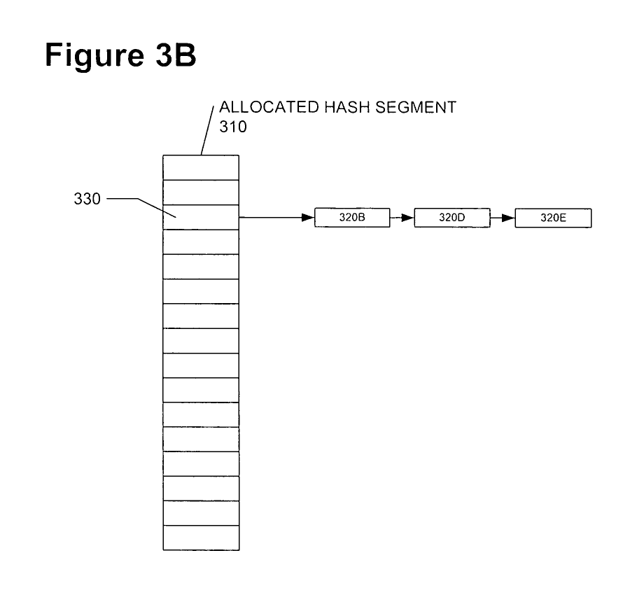

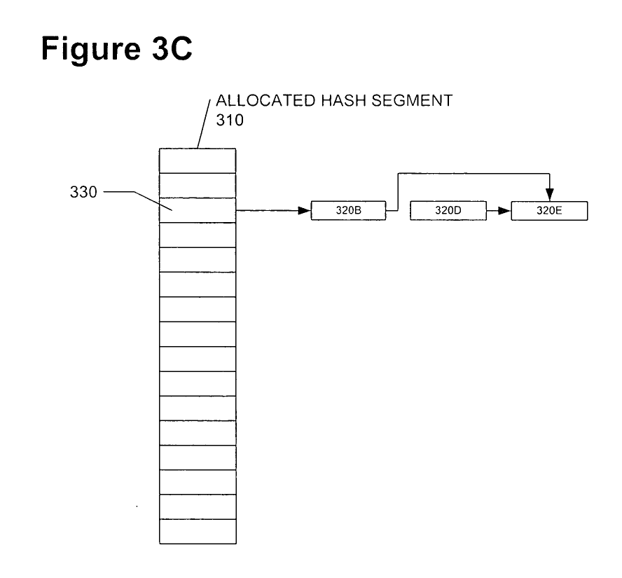

FIGS. 3A and 3B illustrate the algorithm for inserting an item into a segmented linear hash table in accordance with an exemplary embodiment of the present invention. Insertions are straightforward. After the lock is acquired to hold off other modifications (not lookups) to the bucket list 330 of the allocated hash segment 310, FIG. 3A illustrates linking the new item 320B to the first item 320D on the bucket list. Then, as FIG. 3B illustrates, the bucket list 330 is made to point to the new item 320B. Remember that on both a PA and IA processor, writes of scalar types (like pointers or the packed n_i value) are atomic. This may be compiler dependent, but it would be extremely unusual for a compiler to not do this. If surety is needed, these critical writes can be done using inline assembly statements. So, if a reader is racing a writer for a pointer, the reader will either see the old value or the new value, not a mixture of bytes from each.

Note that if a lookup thread is racing the insertion (without using the lock), it will either see the first item 320D in FIG. 3A or the new item 320B in FIG. 3B. But, it will not get confused with respect to the rest of the list.

FIG. 3C illustrates the algorithm for deleting an item from a segmented linear hash table in accordance with an exemplary embodiment of the present invention. Deletions are even simpler. If the item to be deleted 320D is not the first item in the bucket list, the item preceding 320B the item to be deleted 320D is relinked to the item following 320E the item to be deleted 320D. Alternatively, if the item to be deleted is the first item in the bucket list (not shown), the bucket is relinked to the item following the item to be deleted. Alternatively, if the item to be deleted is the last item in the bucket list (not shown), the item preceding the item to be deleted is relinked to indicate that it is the last item in the bucket list.

Again, if a lookup thread is operating concurrently with a deletion, it may or may not see the item to be deleted 320D, but it will not be confused with respect to the rest of the list as long as the item to be deleted 320D continues to point to the item following the item to be deleted 320E for a suitable period of time to allow it to continue searching down the list. The “time” issue will be discussed below.

### Grow the Table

The “grow” algorithm will be triggered when the metric used to measure “fullness” of the hash table reaches an implementation-dependent threshold. This threshold should be the point at which per-bucket operations would reach an expected performance level that is unacceptable (e.g., excessive average search chain length). An effective way to implement the grow algorithm is to instrument the insert code to check if the operation has crossed the threshold. This check can be approximate, so no read locking is necessary. However, when updating the current count of elements, atomic increments and decrements should be used. If the insert code checks whether the operation has crossed the threshold, a kernel daemon should be awakened to do the actual growing of the table so the thread doing the insert does not get delayed in returning to the caller (by “borrowing” the lookup thread itself to do the grow algorithm).

If the growing and shrinking of the table is done by a single kernel daemon, there is no need to worry about additional synchronization for multiple grow or shrink operations. One of the flags in the TABLE-GLOBAL fields 230 shown in FIG. 2 is a “daemon_sched” flag that is used to avoid unnecessary wakeup calls by further table insertions. The daemon_sched flag is set to one by the first “insert” thread to schedule the daemon. Races with other concurrent insertion threads also attempting scheduling are harmless (since they will all attempt to set the flag to one). The goal of the daemon_sched flag is to avoid having all the insertion threads waste their time on redundant scheduling operations. The daemon will clear the daemon_sched flag before going back to sleep.

A target table density metric should be used to determine the new size of the table (also applies to shrinking, though the target values will differ). The target should be roughly in the middle of the grow and shrink threshold values (hysteresis) to avoid oscillation of the table size.

Note that “table size” here refers to the apparent size of the table, n. For simplicity and performance, the physical space occupied by the table is always an integral number of segments (partial segments are not allocated). Note that immediately after a segment is added to the table, the insert, delete and lookup table operations are still seeing a table of the original size, even though we have added room to the table (because n hasn't changed yet). The next part of the algorithm shows how the daemon gradually makes use of the new space to expand the table.

The lower-indexed segments are always completely used (all indices active). The last segment will generally be partially used. This is a design choice with respect to space usage. When a new segment is allocated, the algorithm may choose to fully populate it, using all the hash headers. This would spread out the items and minimize the length of all the bucket chains, maximizing the search speed. However, since the goal is to keep these chains short, on average anyway, using the whole segment would be overkill. Worse yet, if the table shrinks shortly after growing, then all the time needed to populate, then de-populate the last segment will have been wasted. For these reasons, the algorithm only grows into the last segment by as much as the average chain length calls for.

Now, when the daemon opens up fresh space in the uppermost segment to visibly grow the table, the daemon must determine where to find the items that belong in the first new bucket. Since the algorithm for placing these items is deterministic, all items will be found in the same bucket (i.e., the bucket where the subtraction m−2⁽ⁱ⁻¹⁾ puts the item when m exceeds n). The daemon can index the table to the appropriate bucket and acquire the bucket lock. No global table locking is needed if this daemon is the only thread that will ever modify the table. This allows concurrent access by inserting, deleting (and lookup) threads to all other indices that are not being modified by the grow/shrink daemon. A special case, which is outlined below, must be handled when n is a power of two (in order to grow n, i has to be incremented also). Note that the bucket lock acquired will protect both the old and new buckets because of the power-of-two relationship between both the bucket and lock indices.

With exclusive access to both lists of hash items, the daemon increments the global variable n to allow lookup threads access to both buckets, then searches the list for the lower bucket to find items that need to be moved to the upper list. It does this by applying a mask to the original hash value for each item to determine whether the item should stay in this bucket or move to the one being “allocated”. For performance reasons, as shown in FIG. 2, these hash values are stored in each item 220 with the full key (see HASH and KEY in FIG. 2.) If an item must be moved, it is deleted from the old list and inserted in the upper list as described in the Insert/Delete Basics section above. After the entire lower bucket chain has been processed, the lock on the buckets is dropped.

Any thread that had mistakenly computed an index based on the old value of n or i will realize this. For lookup threads, this will happen when the item isn't found and the thread checks to see whether the daemon has been operating on the list, as described below. For insert and delete threads, this realization will happen by similar checks, once the bucket lock is acquired. No bucket other than the one that was modified by the grow thread can have miscomputed an index based on these two values of n, so there is no need to synchronize with these threads because they will get the right answer regardless of which value of n they read.

The final case to consider is when n is a power-of-two before the grow step. In this case also, a mistake in computing the bucket index will put the lookup/insert/delete thread in the lower bucket and the mistake will be corrected when the index is recomputed, as described above.

As with all complicated descriptions, pseudo-code usually helps to clarify:

```
Grow(table) {
  /* First allocate a new table segment, if needed */
  new_table_size <- elem_count / target_per_bucket;
  new_segment_count <- roundup(new_table_size/
  BUCKETS_PER_SEG);
  if (new_segment_count > table->segment_cnt) {
    table->root_array[table->segment_cnt]
      <- malloc(BUCKETS_PER_SEG * sizeof(hash_header));
    /* Init segment: zero counts, NULL pointers, etc. */
    bzero(table->root_array[table->segment_cnt],
      BUCKETS_PER_SEG * sizeof(hash_header));
    table->segment_cnt++;
  };
  /* Start filling in the new buckets */
  n_val <- table->n;
  i_val <- table->i;
  for (m <- table->n; m < new_table_size; m <- m + 1) {
    /*
    * Update local copies of n and i.
    */
    if (is_power_of_two(n_val)) i_val <- i_val + 1;
    n_val <- n_val + 1;
    src_index <- m − (2\hat{ }(i_val − 1);
    src_segment <- table->root_table[src_index >> SEG_BITS];
    src_bucket <- &src_segment[src_index & SEG_MASK];
    dest_segment <- table->root_table[m >> SEG_BITS];
    dest_bucket <- &dest_segment[m & SEG_MASK];
    /* lock both the source and dest buckets (same lock) */
    lock(table->lock_pool[m & LOCK_MASK]);
    /*
    * Indicate to searching threads that the daemon is active.
    */
    src_bucket->flags <- src_bucket->flags | DAEMON_ACTIVE;
    dest_bucket->flags <- dest_bucket>flags | DAEMON_ACTIVE;
    /*
    * Initialize dest_segment[m & SEG_MASK] bucket
    */
    dest_bucket->item_head <- NULL;
    /*
    * Update the table values of n and i to make new bucket
    * visible. These values are packed and written
    * atomically.
    */
    table->n <- n_val;
    table->i <- i_val;
    /*
    * Searching threads may now start looking at either
    * upper or lower bucket even though items have not moved
    * up to the higher bucket yet. Finding the right bucket
    * is handled by the search algorithm.
    */
    /* move “wrapped” entries from corresponding old bucket */
    src_item <- src_bucket->item_head;
    prev_item <- NULL;
    while (src_item != NULL) {
      value <- src_item->hash & ((2\hat{ }i − 1);
      temp_item <- src_item;
      src_item <- src_item->next;
      if (value = m) {
        /* hash value has one in newly “uncovered”
          bit. Move item to destination bucket. */
        if (prev_item == NULL) {
            src_bucket->item_head
              <- temp_item->next;
        } else {
            prev_item->next
              <- temp_item->next;
        }
        temp_item->next <- dest_bucket->item_head;
        dest_bucket->item_head <- temp_item;
      } else {
        prev_item <- temp_item;
      } /* end IF */
    } /* end WHILE loop */
    /*
    * Increment the era and tell other threads that daemon is
    * done with bucket.
    */
    src_bucket->era <- src_bucket->era + 1;
    src_bucket->flags <- src_bucket->flags & ~DAEMON_ACTIVE;
    dest_bucket->era <- dest_bucket->era + 1;
    dest_bucket->flags <- dest_bucket->flags & ~DAEMON_ACTIVE;
    unlock(table->lock_pool[src_index & LOCK_MASK]);
  } /* end FOR loop */
  /*
  * Test whether another grow/shrink operation is still needed
  * before clearing daemon_sched flag.
  */
}
```

The grow algorithm uses the FLAGS field of each bucket to indicate which bucket the grow operation is currently operating upon by setting the DAEMON_ACTIVE flag. The algorithm also flags the bucket as having been touched by incrementing the ERA value when operating upon the bucket is complete. Searching threads can therefore know when they have seen all items that may have been moved to the bucket by a grow operation. In other words, if they scan the bucket list and the ERA value hasn't changed in the meantime and the daemon was not active at the beginning or end of the search, then the grow operation has not added or removed items to the list while the search was in progress.

### Shrink the Table

The algorithm for shrinking the table follows the same principles as the grow algorithm, but the operations must be done in a different order. Once the target size for the new table is calculated, the buckets that will be removed from the table will first need to have their items moved down to the corresponding buckets that will remain in the table.

Notice that since the table is segmented, memory will not actually be freed until the table shrinks across a segment boundary. Once this is accomplished, the evacuated table segment will be held in quarantine for a “suitable” amount of time to ensure that all threads have searched their way into the remaining segments. Again, this “time” issue will be discussed below.

Pseudo-code for the shrink algorithm is as follows. Note that the pointers in the following pseudo-code differ from those in the grow algorithm in that the destination for relocated items was the higher bucket for the grow algorithm and is the lower bucket for the shrink.

```
Shrink(table) {
  /*
  * Move all the items in each bucket being evacuated to lower
  * buckets in the table.
  */
  for (m <- (table->n − 1); m >= target_size; m <- m − 1) {
    dest_index <- m − (2\hat{ }(table->i − 1));
    dest_segment <- table->root_table[dest_index >> SEG_BITS];
    src_segment <- table->root_table[m >> SEG_BITS];
    src_bucket <- &src_segment[m & SEG_MASK];
    dest_bucket <- &dest_segment[dest_segment & SEG_MASK];
    /* lock both the source and dest buckets (same lock) */
    lock(table->lock_pool[m & LOCK_MASK]);
    /* Concatenate source item list to destination item list */
    temp_tail <- src_bucket->item_head;
    while (temp_tail != NULL && temp_tail->next != NULL)
      temp_tail <- temp_tail->next;
    if (temp_tail != NULL) {
      temp_tail->next <- dest_bucket->item_head;
      dest_bucket->item_head <- src_bucket->item_head;
    }
    /* Reduce the table size */
    /* n and i are packed together and written atomically */
    table->n <- table->n − 1;
    if (is_power_of_two(table->n)) table->i <- table->i − 1;
    src_bucket->item_head <- NULL;
    unlock(table->lock_pool[m & LOCK_MASK]);
    /*
    * Searching threads will now stop looking at the upper
    * bucket. Since we did not touch the upper bucket, and
    * since the related item chain is still intact, if they
    * use old values of n or i, they will still locate the
    * item as though the chain hadn't moved.
    /*
    if ((m & SEG_MASK) == 0) {
      /* last bucket in upper segment was just evacuated */
      table->segment_cnt−−;
      /*
      * Add src_segment to quarantine list. Segment array
      * will still point to the quarantined segment so
      * that racing lookup threads don't get lost.
      /*
    }
  } /* end FOR loop */
  /*
  * Test whether another grow/shrink operation is still needed
  * before clearing daemon_sched flag.
  */}
```

### Lookup

The data structures and manipulations have been arranged such that a searching thread will never get lost. However, to accomplish this, the present invention must take some action to ensure that a searching thread will not be indefinitely preempted after it has retrieved a table value or structure pointer that could become stale over time. Otherwise, the table may change too much out from under the thread. This is accomplished by disabling interrupts during the period of time when all the values need to be coherent. Note that table values or structure pointers may still be changing because of concurrently-executing threads (which we will discuss shortly), but they will never be excessively stale. By enabling interrupts after each search attempt, the interrupts are not held off any longer than necessary.

The following is the pseudo-code for the lookup algorithm:

```
Lookup(table, key) {
  do {
    DISABLE_INTS;
    hash <- hash(key);
    index <- Get_index(table, hash);
    target_segment <- table->root_table[index >> SEG_BITS];
    bucket <- &target_segment[index & SEG_MASK];
    initial_era <- bucket->era;
    need_restart <- bucket->flags & DAEMON_ACTIVE;
    item <- bucket->item_head;
    while (item != NULL) {
      if (item->key == key) {
        ENABLE_INTS;
        return(item); /* found it! */
      }
      item <- item->next;
    } /* end WHILE loop */
    /*
    * Check if the thread may have missed any items
    /*
    new_index <- Get_index(table, hash);
  /*
  * Early evaluation will stop execution once any OR
  * condition is satisfied.
  /*
    need_restart <- ((need_restart) ||
            (new_index != index) ||
      (bucket->flags & DAEMON_ACTIVE) ||
            (initial_era != bucket->era));
    ENABLE_INTS;
  } while (need_restart);
  return(NULL); /* item not found */
}
```

Let's look at each of the cases where a lookup might be racing another thread. First, concurrent lookups proceed in parallel because no locks are used. Second, lookups that do not involve buckets that are concurrently involved with an insertion, deletion, grow or shrink operation proceed unimpeded, of course. The remaining cases of interest involve races on the same bucket chain(s).

Based on the basic pointer operations for insertion and deletion operations discussed above, a lookup concurrent with an insertion on the same bucket chain may fail to see the new item if the insertion has not yet completed the relinking illustrated in FIG. 3B. But, this is an unavoidable accident of the race between threads (e.g., if an interrupt delayed the start of the insertion operation, the item would not be found by the lookup thread either). Also, a search concurrent with a deletion may or may not see the deleted item (item 320D shown in FIG. 3C), but it will see all other items on the list. Again, this is an unavoidable accident of the race.

A lookup concurrent with a table shrink that is in the process of manipulating the related bucket chains will find the item either via the old index or the new index without any delay. Either it will see the old values of n and i and find the item via the old index values, or it will see the new values, in which case the upper bucket list will have been linked to the lower bucket.

So the remaining case is where a lookup is concurrent with a table grow operation that is impacting the related bucket chain. Rather than attempt to look at all of the cases where the lookup thread may have missed the item for which it is searching because the daemon has modified the bucket chain(s), it is easier to pin down whether or not the daemon is, or has been, active in the bucket while it was being searched. With the combination of the ERA count and the DAEMON_ACTIVE flag, the search can detect activity and restart the search if necessary.

However, there is still one case to consider: when the search thread computes the bucket index based on the old value of n, but the daemon runs to completion before the search thread can check the DAEMON_ACTIVE flag or save the initial ERA value. To fix this, at the end of the search the bucket index is recomputed to be sure that the correct bucket was searched.

If there is a chance that the search thread has missed an item due to the daemon being active, it will restart its search until it can be sure the item is not present. This should not be long at all, since we are working to keep the bucket chains short. Also, the table grow operation cannot be delayed while it is working on the chain because it holds a spinlock, which disables interrupts.

### Insert/Delete an Item

Here is the pseudo-code for insertions and deletions:

```
Insert(table, key, item) {
  /* Get the initial (trial) index value-could be wrong. */
  hash <- hash(key);
  temp_index <- Get_index(table, hash);
  lock(table->lock_pool[temp_index & LOCK_MASK]);
  /*
  * Now every bucket in the table that items could be moved to
  * from the initial temp_index has been locked so further n and i
  * changes can't affect this insertion. Find the final index now.
  /*
  index <- Get_index(table, hash);
  target_segment <- table->root_table[index >> SEG_BITS];
  bucket <- &target_segment[index & SEG_MASK];
  temp_item <- bucket->item_head;
  /*
  * The following while loop can be removed if we are certain that
  * items with duplicate keys will never attempt to be added.
  /*
  while ((temp_item != NULL) && (temp_item->key != key) {
    if (temp_item->key == key) {
      unlock(table->lock_pool[index & LOCK_MASK]);
      return(DUPLICATE_KEY_ERROR);
    }
    temp_item <- temp_item->next;
  } /* end WHILE loop */
  /* not a duplicate, go ahead and insert it in the table */
  item->key <- key;
  item->hash <- hash;
  item->next <- bucket->item_head;
  bucket->item_head <- item;
  unlock(table->lock_pool[temp_index & LOCK_MASK]);
  /* count items for table fullness */
  ATOMIC_INCREMENT(table->item_cnt);
  return(OK);
}
Delete(table, key) {
  /* Get the initial (trial) index value-could be wrong. */
  hash <- hash(key);
  temp_index <- Get_index(table, hash);
  lock(table->lock_pool[temp_index & LOCK_MASK]);
  /*
  * Now every bucket in the table that items could be moved
  * between the initial temp_index and another index has been
  * locked so further n and i changes can't affect this deletion.
  * Find the final index now.
  /*
  index <- Get_index(table, hash);
  target_segment <- table->root_table[index >> SEG_BITS];
  bucket <- &target_segment[index & SEG_MASK];
  item <- bucket->item_head;
  /*
  * Could replace the following “if” statement by treating bucket
  * head pointer as a pseudo item->next pointer.
  /*
  if ((item != NULL) and (item->key == key)) {
    bucket->item_head <- item->next;
    ATOMIC_DECREMENT(table-> item_cnt);
    unlock(table->lock_pool[temp_index & LOCK_MASK]);
    return(SUCCESS);
  }
  prev_item <-item;
  item <- item->next;
  while ((item != NULL)) {
    if (item->key == key) {
      prev_item->next <- item->next;
      ATOMIC_DECREMENT(table->item_cnt);
      unlock(table->lock_pool[temp_index & LOCK_MASK]);
      return(SUCCESS);
    }
    prey_item <-item;
    item <- item->next;
  } /* end WHILE loop */
  unlock(table->lock_pool[temp_index & LOCK_MASK]);
  return(ITEM_NOT_FOUND_ERROR);
}
```

### Quarantine Time

As mentioned above, when time-critical lookup operations are in progress, interrupts are explicitly disabled. Also, when table operations (grow/shrink, insert/delete) are in progress, interrupts are implicitly disabled because a spinlock is held. Therefore, in all cases, threads will only be following links in the data structures, or visiting an intermediate item (i.e., not the item being sought) for a bounded amount of time. The algorithm still accounts for possible differences in CPU speed in a Non-Uniform Memory Architecture (NUMA) system, but overall the time is bounded. The algorithm depends on this time bounding in order to avoid holding locks during lookups. Another equivalent embodiment of the quarantine algorithm is a deterministic (non-time based) algorithm that, while it may need more CPU cycles to complete, would produce fewer memory errors if the time bound is inaccurate. In yet another embodiment, the quarantine may use a known garbage collection algorithm, or another algorithm, that utilizes specific hardware and software features of the operating environment to safely reclaim memory.

When an item or a hash segment is deleted, it is possible that one or more threads still have references to these objects during this bounded amount of time. Therefore, the algorithm leaves the relevant pointers undisturbed and holds the deleted item on a “quarantine” list long enough for all the threads to have moved on (plus a safety factor). After this “safe” time has elapsed, the algorithm can deallocate or reuse the memory with impunity. A daemon thread prunes the quarantine lists.

### Example of Table Growth

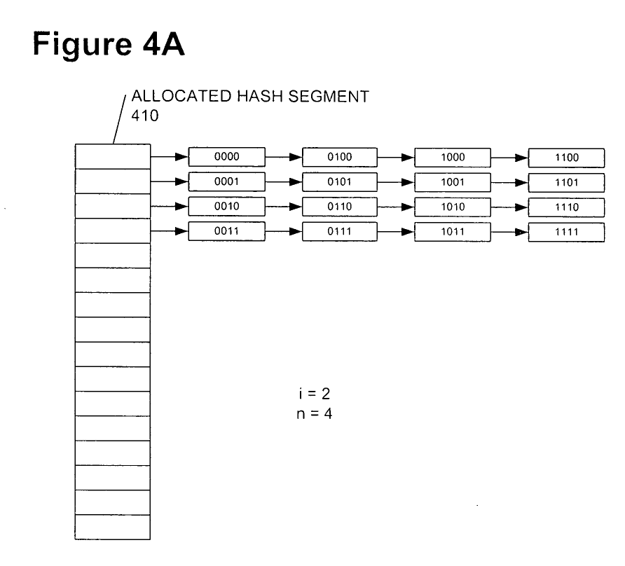

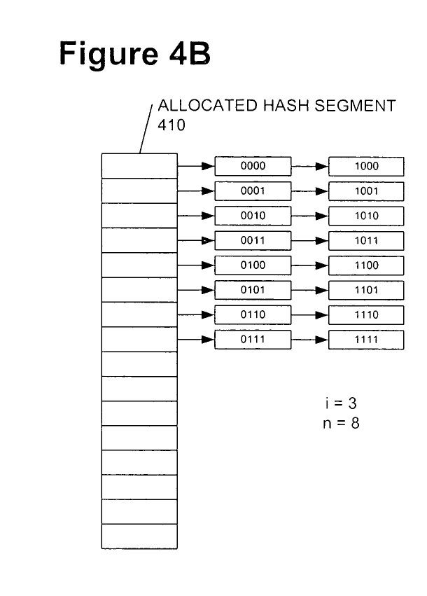

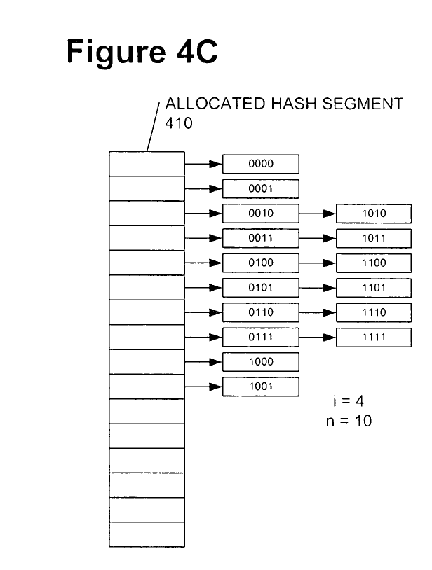

FIGS. 4A, 4B, and 4C illustrate the movement of items from one bucket to another bucket as a segmented linear hash table grows in accordance with an exemplary embodiment of the present invention. For the sake of example, FIG. 4A shows the table initially fully-populated for four bits, with i=2 and n=4.

FIG. 4B shows the table in FIG. 4A, with i=3 and n=8, and with no items deleted, and no new ones inserted, and after it has grown by four buckets, four loops in the grow pseudo-code. As can be seen, the items where a one is uncovered by the new, wider bit mask get moved down to the new buckets. The items from the first bucket going to the fifth bucket, the items from the second bucket going to the sixth bucket, the items from the third bucket going to the seventh bucket, and the items from the fourth bucket going to the eighth bucket.

One item initially of concern is what becomes of the items left in the bottom buckets that have ones in the upper bits, such as the item with 1000 in the first bucket. FIG. 4C shows the table in FIG. 4B, with i=4 and n=10, and that when the next power-of-two boundary is crossed, the grow algorithm goes back to the bottom buckets to pick up these items.

### Practical Considerations for Implementation

The segmented linear hashing algorithm disclosed herein is a general purpose algorithm described in very abstract terms. However, there are several practical concerns that must be addressed before an implementation is attempted.

### Hash Function:

The ideal hash function would distribute the hash values uniformly across the entire hash space (e.g., 64-bits). This would have the effect of dividing the set of hashed items into two sets of roughly the same order each time the i bit is incremented. This would ensure that each “grow” operation of the table will redistribute about half of the items in each bucket (once the number of buckets is expanded through the space opened up by i).

If the key namespace is uniformly distributed and dense (or at least is non-periodic), it may be used as the hash value directly. The uniformity will avoid seeing “hot spots” of activity in the table while a large portion of the table remains empty. The denseness quality makes sure that certain buckets will not be guaranteed to be empty because no key exists to index that bucket (e.g. keys have all zeros in the least significant bits). The caveat is that if there is no regular interval between keys, then the “folding” done by the hash algorithm will not overlay the items in the same set of buckets. An example of sparse keys that may have good hash behavior would be the set of prime numbers.

Small modifications may be made to the key to make it dense within the namespace (such as the right shift operator). During the key transformation, giving the same hash value to multiple keys should be avoided. If this happens, the table growth algorithm will never be able to hash those items to separate buckets.

If the key cannot easily be transformed, another alternative may be suggested. If the key is a numeric (integral) value (e.g. disk block number), it may be used as a seed value of a pseudorandom number generator. This should make sequential access look random and distribute hash values across the space of available hash values (instead of “clumping”). The pseudo-random function is also deterministic (i.e. it will produce the same result on the same input value). This makes the function suitable for this algorithm.

However, note that “clumping” is only a problem when multiple hash values are placed in the same bucket, since it is then that the bucket chains grow in length and search time. Clumping in adjacent buckets is as good as randomly spread values, except for short-term time artifacts during table growing and shrinking. If the key were used almost directly (e.g., by right-shifting and masking), sequential access could potentially ensure that items are placed in different buckets, rather than relying on a pseudo-random number generator to do this by chance.

### Resizing the Table:

There are two threshold values used to determine whether to trigger a grow or shrink operation on the table, but not much detail has been given about how these values are derived or utilized.

These two thresholds need to be a measure of table “fullness” and will have values consistent with desired lookup speeds. These thresholds are most simply implemented as a ratio of elements over n. For example, a threshold of 1 would represent an equal number of elements to hash headers. A value of 2 would be twice as many elements as hash headers (i.e. average chain length is 2), and so on.

Each insert or delete operation checks the count of elements versus the current value of n to determine if a resize is appropriate. At this point, the modification thread will wake up the daemon (if it is not already busy or waiting to run) to perform the appropriate resize. (For simplicity, this is not completely illustrated in the pseudo code above.)

The daemon will wake up and compute a target size based on additional ratio values input by the user. This can be a single value or separate values for the grow and shrink operations. This is the ratio to approximate after the resize completes. The resize daemon will choose an appropriate new value for n based on this ratio and resize accordingly.

For example, consider an implementation that has a shrink threshold of 0.5 and a grow threshold of 2. The daemon will maintain a table that varies in average bucket chain depth between 0.5 and 2 elements per bucket. If the grow target ratio is set to 1 and a grow is triggered, the table size will approximately double to set the new ratio to one. Likewise, if the same ratio of 1 is used for shrink, the table will be halved to reach to desired ratio.

In addition to the thresholds and target ratios, which are necessary for the operation of the algorithm, additional tolerances can be introduced to improve the resize efficiency. The first set of tolerances will avoid a “rubber band” effect where the target ratio is too close to one of the threshold ratios and an inverse resize is triggered too quickly. This could lead to rapid table size oscillation and reduced performance.

These two tolerances are really a delay to introduce between inverse operations, shrink-after-grow and grow-after-shrink. A minimum value is required for grow-after-shrink for correct implementation of quarantines (see below). For the shrink-after-grow period, there are no correctness concerns. However, this value will determine how slowly the algorithm will attempt to reclaim memory after a grow operation.

Another useful tolerance value would be how long the usage is beyond one of the threshold values before waking the daemon to perform the resize. This allows bursts of activity to be tolerated without triggering an unnecessary table resize. For example, if the shrink tolerance was set to five minutes, usage could dip below the threshold, but if it got back over the shrink threshold before the five minutes elapsed, no shrink will be triggered. Checking if the conditions are met for the shrink can be continuous (every table modification) or only recheck the threshold at the end of five minutes. Most likely, the daemon will check these conditions each time it runs, rather than the modification threads.

Another strategy that can be employed to make table growth more adaptable is to have the daemon recognize rapid (or accelerating) growth. If another grow is triggered within a specified time period, it will indicate to the daemon that it may need to be more aggressive about growing the table. A percentage value can be provided by the user to indicate how much more aggressive subsequent grow operations should be. The percentage will be applied to the target ratio value used for the previous grow. Using the previous example of a target ratio of 1, the next grow would use 0.75 as the target ratio (then 0.56, etc.), stopping at the shrink threshold. As soon as the window for accelerating growth has passed without another request, the target is reset to the original value of 1 since the daemon has “caught up” with the usage.

Many more metrics or tolerances could be envisioned. However, the above set should allow significant flexibility and control over the algorithm for the user. Note that some of the above parameters may be private to the implementation and not settable by the user.

### Synchronizing Access to Hashed Items:

The present invention discusses, in great detail, the synchronization of access to the control structures of the hash table. However, synchronization of the users' hash items has been left as a problem for users of the hash to solve. Some ideas to help develop a synchronization scheme are presented in this section.

The first thing to avoid would be any kind of locking (even a read/write lock) when doing a lookup. This will tend to defeat the inherent benefit of lookup-without-locking synchronization used in the hashing algorithm and reduce parallelism.

The biggest concern for the user is a lookup racing with a delete operation. This is an external race (from the perspective of the hash table), so it can only be avoided by the user. If both the lookup and the delete (from the hash table) succeed, the user's lookup thread will have a reference to the object, which is no longer linked to the hash due to the delete. If the user's delete thread decides to reuse or free the memory of that item, the other thread could have an unexpected error, or worse, panic the system.

If possible, some external protocol should ensure that the delete operation would only be performed when it is no longer possible that searches for that key will be in progress. This means that lookups may pass through the deleted item (which is handled with the quarantine), but will not keep a pointer to it.

In many cases, however, this may not be possible. This is especially true when the hash is used as a cache. The lookup may be in progress for an item that is scheduled to be replaced (i.e., reused by a least recently used (LRU) or similar algorithm). In this case the race is unavoidable.

To combat this, the most straightforward solution is to add a reference count to the item and only free it when the reference drops to zero. There are other more involved ways to keep track of the object, such as setting a “busy” flag or acquiring a lock (either from a pool or embedded within the item).

Because interrupts are reenabled before the item pointer is returned to the user, the lookup thread may be significantly delayed before it has a chance to take any action concerning the found item. To resolve this, when the table is initialized, the user may specify an optional function variable to be called by the lookup function before returning the found reference to the user (use of this function variable is not indicated in the pseudo code above). A function call is only one design for enabling a user to correctly synchronize access to the item stored in the hash table. It will be apparent to any individual skilled in the art that a variety of design choices for synchronizing user access to an item are possible. These synchronization designs should be considered equivalent for the purposes of this invention. We would have preferred to have avoided the overhead of the function call, however this provided the most utility to the user. This function variable can be NULL for cases where external protocols are possible. It can also manage reference counts, or even acquire locks for the item, or for outside linked lists, etc., that may involve the item. Additionally, a period of time to add to the delete quarantine period can be specified to allow the function variable to signal to the deallocation function that a lookup reference exists (e.g., increment reference count). This provides maximum flexibility while retaining the generality of the Segmented Hash Table utilities as an independent module.

### Implementing Quarantines:

The topic of quarantine periods is discussed throughout this disclosure, but there is no “cookbook” to figure out how these periods can be derived.

First, consider the objects that must be quarantined and when the quarantine period begins for each. There are three events that may require quarantine because there is the potential for a dangling pointer reference:

The first event is a deleted item. Lookup threads walking the list containing this item may have read the pointer for the deleted item (from the hash header or another item) before the link was removed.

The second event is a freed bucket when the table shrinks by one. The hash header that was just “removed” (upper bucket) still points to the list briefly after it was copied to the lower bucket.

The third event is a freed segment when the table shrinks across a segment boundary. The root hash table still references the segment. This is really a special case of the second event.

Since no memory is freed (or pointers invalidated) for the second event, the quarantine period will end before any quarantine period that will invalidate (i.e., free) the dangling reference from the upper bucket. So, first consider what the lookup thread requires in terms of the other two quarantine cases.

When an item is deleted, there is metadata embedded within the structure that is critical to the safety of the threads performing lookups, namely the key, hash value, the pointer to the next chained item in the bucket, and the item itself, if it is the target of the searching thread.

If a thread reads the memory location of the deleted item just before it is removed (either from the bucket head or from another item), the item metadata needs to remain constant until the thread is finished with the deleted item. The quarantine period begins when no reference to the deleted item remains in the table. Note that references can be from the hash header or another element (or both during a shrink).

Considering the possible actions for the lookup thread to take when it beats the delete thread to the target item, there are two paths of execution: 1) the key is not the target key of the search and the thread passes through the item; or 2) the key matches the item and it has been found by the lookup (and will subsequently be returned to the user). The following operations are required by both execution paths:
Read the stored key value (from pointer plus offset).
Compare to the target key value.

For execution path 1) (key doesn't match):
Read the next pointer value (from pointer plus offset).

For execution path 2) (key matches):
Call function variable, if non-NULL, to perform synchronization with delete.
Enable interrupts.
Return item pointer.

The quarantine period for execution path 2) will include the common operations, the time to make the function call (save registers, set up stack, etc.), plus the user-specified period to account for partial or full execution of the function. This latter time period only needs to be long enough to allow the function to signal to the deallocation function that a lookup has found the item (e.g., increment a reference count). The function variable may perform additional operations, but these do not need to be included in the additional quarantine period, as long as they are subsequent to the critical operation(s). The execution path with the longer quarantine period (plus the safety factor) will determine the final quarantine period for a deleted item.

When this quarantine period has elapsed, a deallocation function, provided by the user, will be called on the item. This function will be responsible for checking the item's reference count (flag, lock, etc.), if necessary, and take care of reclaiming the item as the user sees fit. The delete thread should take no action concerning this item: the deallocation function will be called on another thread after the quarantine has elapsed. Modifying the item structure in the delete thread could interfere with the consistency of the hash metadata.

Next to consider is the quarantine needed for a table segment. The quarantine period must begin when n is reduced to no longer reference this segment. At this point, a lookup thread may have used the old value of n to compute the index into the root table and read the pointer to the segment being quarantined.

The operations performed by this lookup thread after reading the old value of n must make up the basis for the quarantine period. The steps are:
Compute the offset into the root table.
Read the segment pointer.
Compute the offset within the segment.
Cache the bucket pointer.
Read and cache the era value.
Read and cache the flag for daemon activity.
Read the item list (bucket) head pointer.

In parallel with this execution path, is the quarantine period that begins for the hash header (bucket) at the beginning of the segment, since that item is vacated at the same time as the segment. This quarantine will also begin just after the value of n has been modified, such that the thread has just read the old value of n. It should be obvious that this quarantine period will need the exact same steps as listed above and can therefore be treated as equivalent.

A necessary optimization to ensure a deterministic quarantine period is to have the lookup thread recompute and check the index value before checking either the daemon flag or the era value stored in the hash header, after it has walked the bucket chain and not found the item. This is necessary because the thread will take an indefinite period of time to walk the chain of items, after which (if the item isn't found) it will try to reference the hash header from which it started the search. If the index is computed first, the lower value of n will be noted and the thread does not need to reference the original hash header at the end of the search, but rather it can restart its lookup from the new bucket index.

To show that no additional steps need to be included in the quarantine of the segment (and the last hash header to be freed from the segment), consider the lookup and modification code. For modifications, there is no danger that the old segment or bucket will have been referenced because the bucket lock is held by the daemon before the modification thread indexes the root table. For a lookup, after reading the list pointer and searching the list, the index value (derived from n) is first rechecked before referencing the cached bucket pointer. If the index has changed (n was invalid), the bucket will not be touched again and the lookup thread will just jump to the new index. In this case it was safe to have ended the quarantine period after reading the bucket head pointer.

Considering the case where the index matches, there are two possibilities: either the bucket is still safe to access (not in quarantine) or a shrink invalidated the segment and a subsequent grow has reinstated the segment. The latter situation can be prevented by providing a sufficient minimum value for the grow-after-shrink tolerance (discussed above in the resizing section). This allows all lookup threads on the old segment enough time to search the bucket and then recognize that a shrink has occurred, preventing a subsequent access to the hash header in the invalidated (freed) segment. A value of, 50 milliseconds for the grow-after-shrink should be sufficient for most applications as a minimum.

After eliminating the possibility of a conflicting grow-after-shrink, the quarantine period for segments will be sufficient to prevent subsequent access to the invalid segment, if it includes the operations mentioned above. After the quarantine period has elapsed, the segment may be safely reclaimed.

Finally, the quarantine for the second event for a hash header must be considered. As shown above, it is not necessary to track a separate quarantine period for the hash header when it also involves a segment quarantine. Now the general case of a hash header quarantine will be considered.

As already mentioned, there is no danger to the search thread in general since the memory is not being reclaimed (only during segment quarantine). The remaining case to be considered is how the quarantine for a hash header will interact with the quarantine of a deleted item.

Since both the shrink and delete operations require the same lock to modify the bucket, these operations will not overlap. The only order of concern is a shrink followed by a delete of the item that was at the head of the recently invalidated bucket. This is because the element can temporarily be referenced from two places (i.e., two buckets or the invalidated bucket and a hash item in the lower bucket chain). Whichever of these is the last reference accessible to a lookup thread will determine when the quarantine period for the delete will begin. Note that the quarantine period must be the same for both paths to the item, since the set of operations defined by the delete quarantine remain constant.

The quarantine for the deleted item can only begin once the last reference from the table is removed (or when any remaining reference is unreachable). The shrink operation will temporarily make the head element of the upper bucket reachable both by the upper bucket as well as the lower bucket list. By setting the head pointer in the bucket to NULL after decrementing n (but before releasing the lock), there remains only one reference to the element. Now when the item is deleted, the final reference is removed and the quarantine will begin. Therefore, quarantine of the bucket is not needed.

To translate the qualitative descriptions of the operations covered by quarantine into a quantitative result, a couple of approaches can be taken. The most reliable is to write the critical sections of code as assembly (to account for compiler differences) and analyze the required instruction cycles (and delay) on the slowest CPU and memory architecture, assuming cache misses on memory references. This is obviously only possible when the CPU architecture is known in advance. Otherwise, instrumented stub code (representing critical quarantined sections) can be called during table initialization to set the quarantine periods. The call should also bind itself to the slowest CPU to get the worst case time. It is expected that all the required quarantine times will be much less than a single time tick (10 milliseconds), and a generous safety margin should be added to compensate for inaccuracies anyway, so the actual times used to schedule the deletion daemon will be much longer than actually required.

### Flow of Operations:

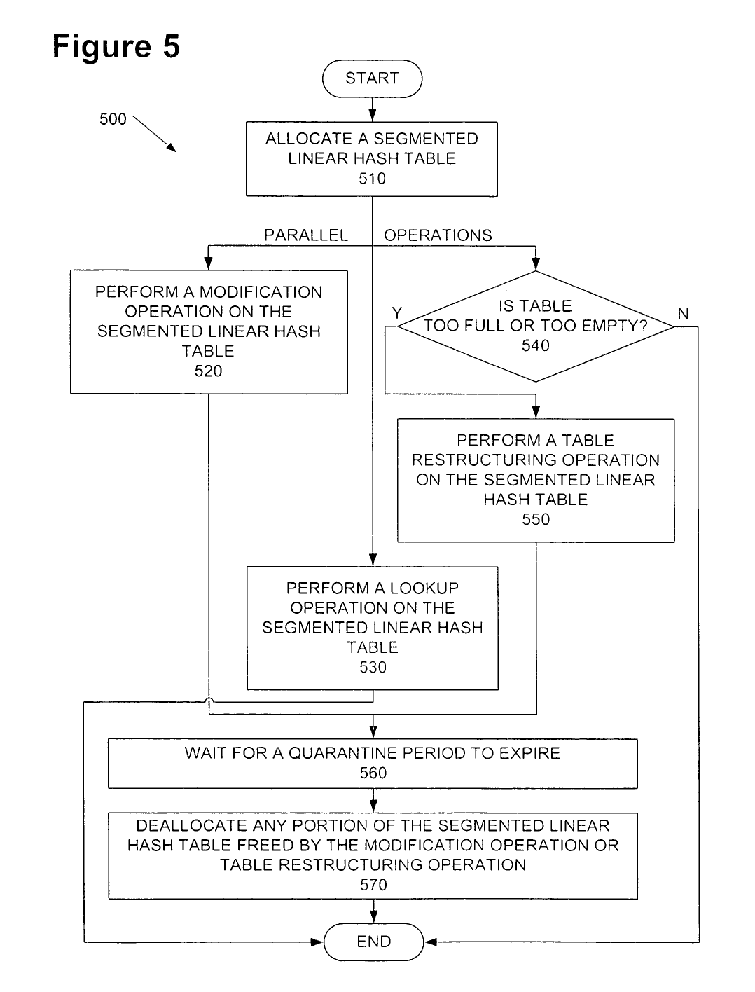

FIG. 5 is a flow diagram of a method for managing access to data records in a multiprocessor computing environment in accordance with an exemplary embodiment of the present invention. The process for managing access to data records 500 begins by allocating a segmented linear hash table (step 510). Once the segmented linear hash table is allocated, the process 500 performs, in parallel, a modification operation on the segmented linear hash table (step 520), a lookup operation on the segmented linear hash table (step 530), and a table restructuring operation on the segmented linear hash table (step 550). Before performing the table restructuring operation, the process 500 determines whether the table restructuring operation is necessary by determining the table fullness metric (step 540). Following the modification operation and the table restructuring operation, the process 500 waits for a quarantine period to expire (step 560) before deallocating any portion of the table freed by either the modification or table restructuring operations (step 570).

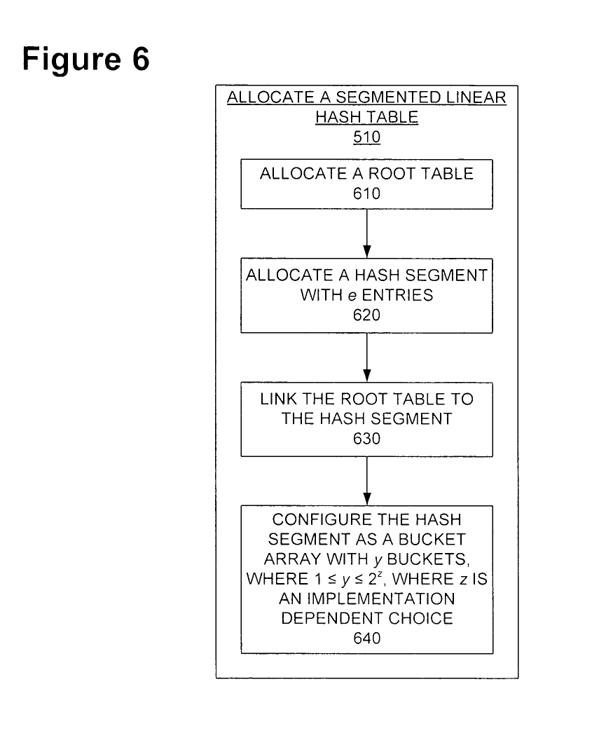

FIG. 6 is a flow diagram that describes the method for allocating a segmented linear hash table shown in FIG. 5 in greater detail in accordance with an exemplary embodiment of the present invention. The allocation of a segmented linear hash table (step 510) allocates a root table (step 610) and a hash segment with e entries (step 620). The allocation operation (step 510) then links the root table to the hash segment (step 630) and configures the hash segment as a bucket array with y buckets, where 1≦y≦2^{z} (step 640), where z is an implementation-dependent choice.

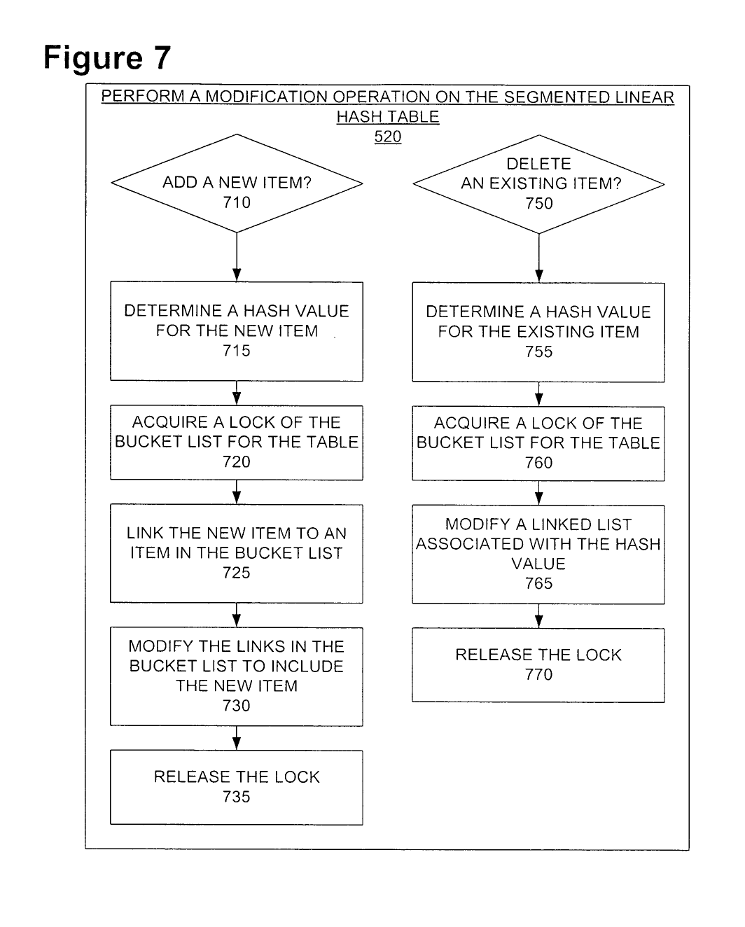

FIG. 7 is a flow diagram that describes the method for performing a modification operation on the segmented linear hash table shown in FIG. 5 in greater detail in accordance with an exemplary embodiment of the present invention. The modification operation includes addition of a new item and deletion of an existing item. If the user elects to add a new item (step 710), the performance of the modification operation (step 520) determines a hash value for the new item (step 715), acquires a lock of the bucket list for the table (step 720), links the new item to an item in the bucket list (step 725), modify the links in the bucket list to include the new item (step 730), and releases the lock (step 735). Depending upon where the new item is inserted in the bucket list, the addition operation may result in a bucket list that is an unsorted list, a sorted list, or any other ordering scheme as chosen by the user. If the user elects to delete an existing item (step 750), the performance of the modification operation (step 520) determines a hash value for the existing item (step 755), acquires a lock of the bucket list for the table (step 760), modifies the linked list associated with the hash value (step 765), and releases the lock (step 770).

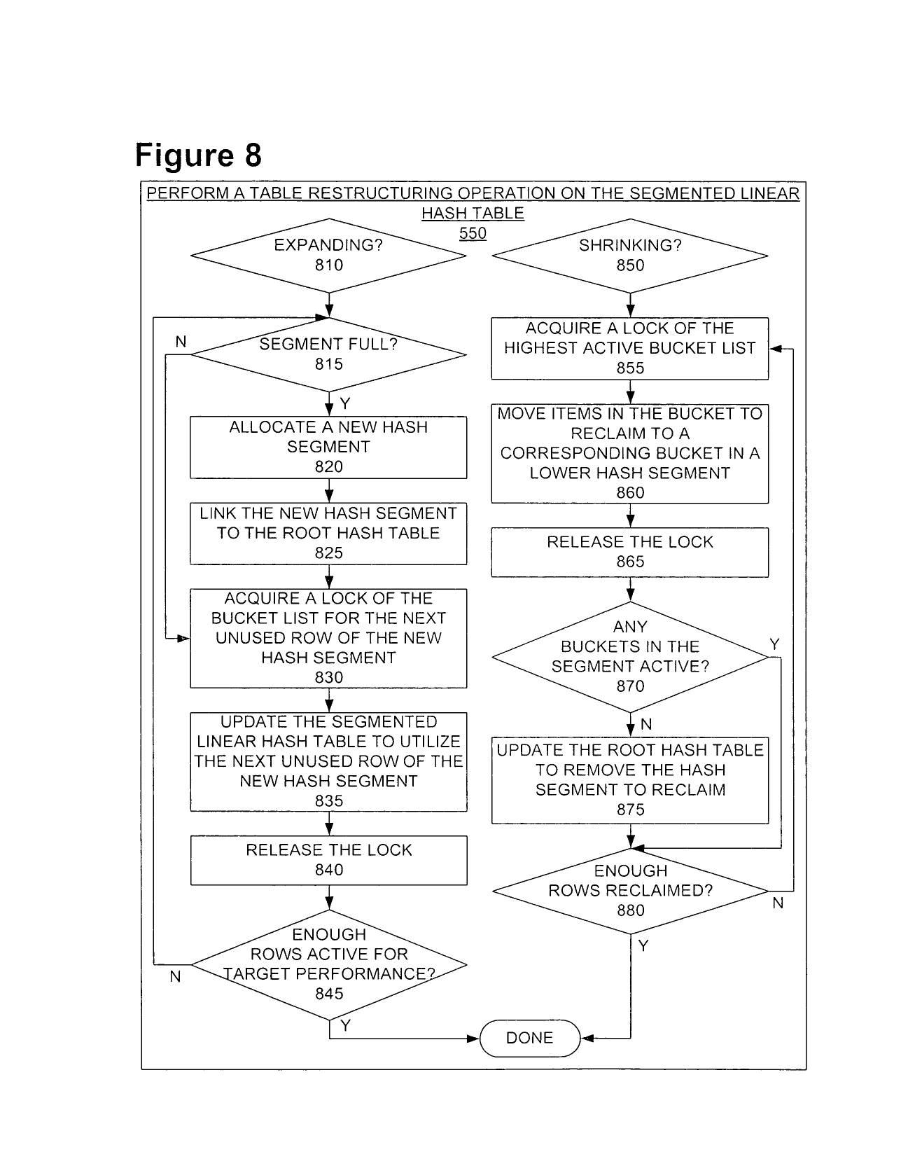

FIG. 8 is a flow diagram that describes the method for performing a table restructuring operation on the segmented linear hash table shown in FIG. 5 in greater detail in accordance with an exemplary embodiment of the present invention. The table restructuring operation includes expanding the table by activating unused rows in the last segment and allocating a new hash segment when the last segment is full (expansion process), and shrinking the table by deactivating rows in the last segment and reclaiming an existing hash segment when all its rows have been deactivated (shrinking process).

As shown in FIG. 8, if the user elects to expand the table (step 810), the performance of the table restructuring operation (step 550) initiates the expansion process by determining whether the segment is full (step 815). If the segment is full (“Y” branch from step 815), the expansion process allocates a new hash segment (step 820), links the new hash segment to the root hash table of the segmented linear hash table (step 825), and acquires a lock of the bucket list for the next unused row of the new hash segment (step 830). If the segment is not full (“N” branch from step 815), the expansion process proceeds directly to acquiring the lock of the bucket list for the next unused row of the last hash segment (step 830). After acquiring the lock of the bucket list (step 830), the expansion process updates the segmented linear hash table to utilize the next unused row of the new hash segment (step 835), releases the lock (step 840), and determines whether enough rows are active to achieve target performance (step 845). If more rows need to be active to achieve target performance (“N” branch from step 845), the expansion process repeats from step 815. If enough rows are active to achieve target performance (“Y” branch from step 845), the expansion process is done.

As shown in FIG. 8, if the user elects to shrink the table (step 850), the performance of the table restructuring operation (step 550) acquires a lock of the highest active bucket list (step 855), moves items in the bucket associated with the hash segment to reclaim to a corresponding bucket in a lower hash segment (step 860), and releases the lock (step 865). The shrinking process then determines whether any buckets in the hash segment to reclaim are active (step 870). If no buckets in the hash segment to reclaim are active (“N” branch from step 870), the shrinking process updates the root hash table of the segmented linear hash table to remove the hash segment to reclaim (step 875), and determines whether enough rows have been reclaimed (step 880). If buckets in the hash segment to reclaim are active (“Y” branch from step 870), the shrinking process determines whether enough rows have been reclaimed (step 880). If the shrinking process needs to reclaim more rows (“N” branch from step 880), the shrinking process repeats from step 855. If the shrinking process has reclaimed enough rows (“Y” branch from step 880), the shrinking process is done.

### Hash Table as a Kernel Service:

To put all of these implementation considerations together, it is useful to think about implementing a segmented linear hash table as a generic service.

The algorithm is highly configurable, so users may have different requirements that can be met using different constraints on the algorithm. To communicate the specific needs of the user, a control structure should be populated and used to create a new table. The following would be expected data values in the control structure:
Maximum number of table segments (top level array size)
Segment size (should be related to the memory page size, most likely will have a common default value)
Spinlock pool size (power of two; maximum is the number of hash headers per segment).
Grow and shrink threshold and target values
Tolerances for detecting rapid growth or oscillation
Metadata location: this can either be represented as a series of offsets into the item for the metadata (key, hash, next pointer) or specify that the algorithm can use a generic metadata structure that will contain the metadata plus a pointer to the item. The separate metadata structure is cleaner (in terms of the quarantine of deleted items), but requires the lookup to follow another pointer.
Hash function pointer
Function pointer for when an item is found by a lookup (optional).
Additional delete quarantine time for lookup function (optional).
Item deallocation function pointer
Thread pool size for doing asynchronous operations such as quarantine expiration (and subsequent cleanup). If unspecified, the grow/shrink thread may be co-opted to do this job.
Optional initial segment count (default is one). This will be the “low water mark” for the shrink algorithm. The table will never shrink below this level.

Once the control structure is populated, the hash table creation function is called and an opaque table reference is returned. Each operation on the table will take the table reference as the first argument.

The operations accessed by the user are defined as follows:

table_ref_t create_table(table_ctl_t *t_ctl);
int insert(table_ref_t t_ref, table_key_t key, void *item);
void *lookup(table_ref_t t_ref, table_key_t key);
void delete(table_ref_t t_ref, table_key_t key);
void destroy_table(table_ref_t t_ref);

The insert operation returns an integer in order to specify an error condition (such as duplicate key existence). The lookup operation will return the item pointer on success or NULL if not found. The semantics of the delete operation are simply to remove the item from the hash if it exists (else no-op). This optimizes by avoiding the need for a lookup to see if the item exists, followed by a delete.

Finally, the destroy_table operation, as expected will free any memory associated with the table. For any items remaining in the table, the deallocation function will be called immediately. This function should not be called until all other activity on the table has ceased.

Although the disclosed embodiments describe a fully functioning system and method for managing access to data records in a multiprocessor computing environment, it is to be understood that other equivalent embodiments exist. Since numerous modifications and variations will occur to those who review this disclosure, the system and method for managing access to data records in a multiprocessor computing environment is not limited to the exact construction and operation illustrated and disclosed. Accordingly, this disclosure intends all suitable modifications and equivalents to fall within the scope of the claims.

What is claimed is:

1. A method for managing access to data records in a multiprocessor computing environment, comprising:
allocating a segmented linear hash table for storing the data records;
performing a modification operation on the segmented linear hash table;
performing a table restructuring operation on the segmented linear hash table in parallel with the modification operation; and
performing at least one lookup operation on the segmented linear hash table in parallel with each other and with the modification operation or the table restructuring operation.

2. The method of claim 1, wherein said at least one lookup operation is performed upon at least one bucket list of the segmented linear hash table, each lookup operation occurring in parallel.

3. The method of claim 2, wherein the modification operation is performed upon a first bucket list of said at least one bucket list in parallel with said at least one lookup operation.

4. The method of claim 3, wherein at least one other modification operation is performed in parallel with the modification operation and in parallel with said at least one lookup operation, each other modification operation performed upon a unique bucket list of said at least one bucket list other than the first bucket list.

5. The method of claim 2, wherein the restructuring operation performed upon one of said at least one bucket list occurs in parallel with said at least one lookup operation.

6. The method of claim 1, further comprising:
deallocating a portion of the segmented linear hash table freed by the modification operation after expiration of a quarantine period.

7. The method of claim 1, further comprising:
deallocating a portion of the segmented linear hash table freed by the table restructuring operation after expiration of a quarantine period.

8. The method of claim 1, wherein the modification operation is an addition of a new item to the segmented linear hash table, further comprising:
determining a hash value for the new item;
acquiring a lock of a bucket list associated with the segmented linear hash table that is to contain the new item;
linking the new item to an item in the bucket list;
modifying the links in the bucket list to include the new item; and
releasing the lock.

9. The method of claim 1, wherein the modification operation is a deletion of an existing item from the segmented linear hash table, further comprising:
determining a hash value for the existing item;
acquiring a lock of a bucket list associated with the segmented linear hash table that is to contain the existing item;
modifying a linked list associated with the hash value to remove the existing item from the linked list; and
releasing the lock.

10. The method of claim 1, further comprising:
calculating a fullness measure for the segmented linear hash table.

11. The method of claim 10, wherein the fullness measure triggers the table restructuring operation to expand the segmented linear hash table, further comprising:
acquiring a lock of a bucket list for an unused row of the segmented linear hash table;
updating the segmented linear hash table to utilize the unused row of the new hash segment; and
releasing the lock of the bucket list after items have been moved to the unused row.

12. The method of claim 11, wherein when the segmented linear hash table is full, further comprising:
allocating a new hash segment for the segmented linear hash table; and
linking the new hash segment to a root table associated with the segmented linear hash table.

13. The method of claim 10, wherein the fullness measure triggers the table restructuring operation to shrink the segmented linear hash table, further comprising:
sequentially acquiring a lock of a bucket list for at least one row associated with a hash segment to reclaim from the segmented linear hash table;
moving items stored in the bucket list to another bucket list in another hash segment in the segmented linear hash table;
releasing the lock of each row after the moving of the items; and
when no bucket lists are active in the hash segment to reclaim, updating a root hash table associated with the segmented linear hash table to remove the hash segment to reclaim.

14. The method of claim 1, wherein the allocating of the segmented linear hash table further comprises:
allocating a root table that includes segment references;
allocating a hash segment that includes e entries, each entry including a head pointer to a linked list of items, each item including a next pointer, a key value, a hash value, and a reference to a data record; and
linking one of the segment references to the hash segment,
wherein a portion of the entries of the hash segment are configured as a bucket list including y buckets, where 1≦y≦2^{z}, where z is an implementation-dependent choice, and
wherein a hash function distributes the key values over the entries of the segmented linear hash table as limited by n.

15. The method of claim 14, wherein the root table is fixed in memory.

16. A system for managing access to data records in a multiprocessor computing environment, comprising:
a memory device resident in the multiprocessor computing environment;
processors disposed in communication with the memory device, the processors configured to:
allocate a segmented linear hash table for storing the data records;
perform a modification operation on the segmented linear hash table;
perform a table restructuring operation on the segmented linear hash table in parallel with the modification operation; and
performing at least one lookup operation on the segmented linear hash table in parallel with each other and with the modification operation or the table restructuring operation.

17. The system of claim 16, wherein said at least one lookup operation is performed upon at least one bucket list of the segmented linear hash table, each lookup operation occurring in parallel.

18. The system of claim 17, wherein the modification operation is performed upon a first bucket list of said at least one bucket list in parallel with said at least one lookup operation.

19. The system of claim 18, wherein at least one other modification operation is performed in parallel with the modification operation and in parallel with said at least one lookup operation, each other modification operation performed upon a unique bucket list of said at least one bucket list other than the first bucket list.

20. The system of claim 17, wherein the restructuring operation performed upon one of said at least one bucket list occurs in parallel with said at least one lookup operation.

21. The system of claim 16, wherein the processors are further configured to:
deallocate a portion of the segmented linear hash table freed by the modification operation after expiration of a quarantine period.

22. The system of claim 16, wherein the processors are further configured to:
deallocate a portion of the segmented linear hash table freed by the table restructuring operation after expiration of a quarantine period.

23. The system of claim 16, wherein the modification operation is an addition of a new item to the segmented linear hash table, and wherein the processors are further configured to:
determine a hash value for the new item;
acquire a lock of a bucket list associated with the segmented linear hash table that is to contain the new item;
link the new item to an item in the bucket list;
modify the links in the bucket list to include the new item; and
release the lock.

24. The system of claim 16, wherein the modification operation is a deletion of an existing item from the segmented linear hash table, and wherein the processors are further configured to:
determine a hash value for the existing item;
acquire a lock of a bucket list associated with the segmented linear hash table that is to contain the existing item;
modify a linked list associated with the hash value to remove the existing item from the linked list; and
release the lock.

25. The system of claim 16, wherein the processors are further configured to:
calculate a fullness measure for the segmented linear hash table.

26. The system of claim 25, wherein the fullness measure triggers the table restructuring operation to expand the segmented linear hash table, and wherein the processors are further configured to:
acquire a lock of a bucket list for an unused row of the segmented linear hash table;
update the segmented linear hash table to utilize the unused row of the new hash segment; and
release the lock of the bucket list after items have been moved to the unused row.

27. The system of claim 26, wherein when the segmented linear hash table is full, the processors are further configured to:
allocate a new hash segment for the segmented linear hash table; and
link the new hash segment to a root table associated with the segmented linear hash table.

28. The system of claim 25, wherein the fullness measure triggers the table restructuring operation to shrink the segmented linear hash table, and wherein the processors are further configured to:
sequentially acquire a lock of a bucket list for at least one row associated with a hash segment to reclaim from the segmented linear hash table;
move items stored in the bucket list to another bucket list in another hash segment in the segmented linear hash table;
release the lock of each row after the moving of the items; and
when no bucket lists are active in the hash segment to reclaim, update a root hash table associated with the segmented linear hash table to remove the hash segment to reclaim.

29. The system of claim 16, wherein to allocate the segmented linear hash table, the processors are further configured to:
allocate a root table that includes segment references;
allocate a hash segment that includes e entries, each entry including a head pointer to a linked list of items, each item including a next pointer, a key value, a hash value, and a reference to a data record; and
link one of the segment references to the hash segment,
wherein a portion of the entries of the hash segment are configured as a bucket list including y buckets, where 1≦y≦2^{z}, where z is an implementation-dependent choice, and
wherein a hash function distributes the key values over the entries of the segmented linear has table as limited by n.

30. The system of claim 29, wherein the root table is fixed in memory.
